(19) United States
(12) Patent Application Publication
(10) Pub. No.: US 2005/0286968 A1
(43) Pub. Date: Dec. 29, 2005

(54) Vernier means for locking members

(76) Inventor: Hugh Gene Loebner, New York, NY (US)

Correspondence Address: HUGH LOEBNER;c/o CROWN INDUSTRIES, 155 N. PARK St, EAST ORANGE, NJ, 07017, US

(21) Appl. No.: 10/877,179

(22) Filed: Jun. 28, 2004

(51) Int. Cl. F16B 7/10

(52) U.S. Cl. 403/109.1

(57) ABSTRACT

Telescoping tubes can have holes distributed in the pattern of a vernier caliper, thereby providing an easy means of locking the tubes in a desired length. Similarly, plates can have holes distributed in two dimensions in the pattern of a vernier caliper's, thereby providing a means of accurately locking size in two dimensions.

### BACKGROUND AND SUMMARY OF THE INVENTION

This invention relates to the application of the vernier effect to joining structures such as telescoping structures and flat plates. I use the term vernier effect to refer to the mechanism by which a vernier caliper can measure distances precisely.

Telescoping structures comprise at least two joined elements which are allowed to move relative to each other in one dimension only. The relative motion of one member relative to the other changes the overall length of the telescoping structure.

Telescoping structures can be used for many purposes. They can be used vertically as legs for tripods, music stands, and scaffolding, etc. or horizontally as drape supports, etc.

This invention relates to the method of stopping the relative movement of one member relative to the other so that the overall length of the telescoping structure can be fixed with great accuracy. Specifically, this invention shows how two or more sets of locking holes arranged in the manner of scribe marks on a vernier caliper can be utilized to fix the length of the telescoping structure. Two linear series of locking holes having different pitches, i.e. spaces between them, are disposed such that a pin inserted into two aligned holes secures the telescoping structure providing great precision in determining the overall length.

The same principle can be applied in two dimensions to plates.

### BRIEF DESCRIPTION OF THE DRAWINGS

FIG. 1 shows member 1 with series of holes 3 and member 2 with series of holes 4. The spacing between holes 4 is 9/10 of the spacing between holes 3. That is, the total space 23 between 10 holes in member 2 is the same as between 9 holes in member 2.

FIG. 2 shows member 2 superimposed on member 1. The superimposition allows the relative positions of holes 3 and 4 to be shown. It can be seen that the two sets of holes line up at positions 5.

FIG. 3 shows member 2 shifted very slightly to the right. The combined length of the telescoping structure has been extended by the offset distance. In this instance the two sets of holes are aligned at positions 6.

FIGS. 4 and 5 show two alternative cross sections showing how members 1 and 2 can be constrained to move relative to each other in one dimension only. FIG. 4 shows members 1 and 2 as triangular. FIG. 5 shows members 1 and 2 as “U” channels. Many other shapes are possible. Also shown in FIGS. 4 and 5 is pin 6 which locks the two members 1 and 2.

FIGS. 6 and 7 show how it is possible to stagger the holes into several rows if the distance between holes is small compared to the diameter of the holes.

FIG. 8 shows the arrangement of holes disposed on three sides of two triangular tubes 1 and 2.

FIGS. 9 and 10 show how the vernier principle can be applied to two plates.

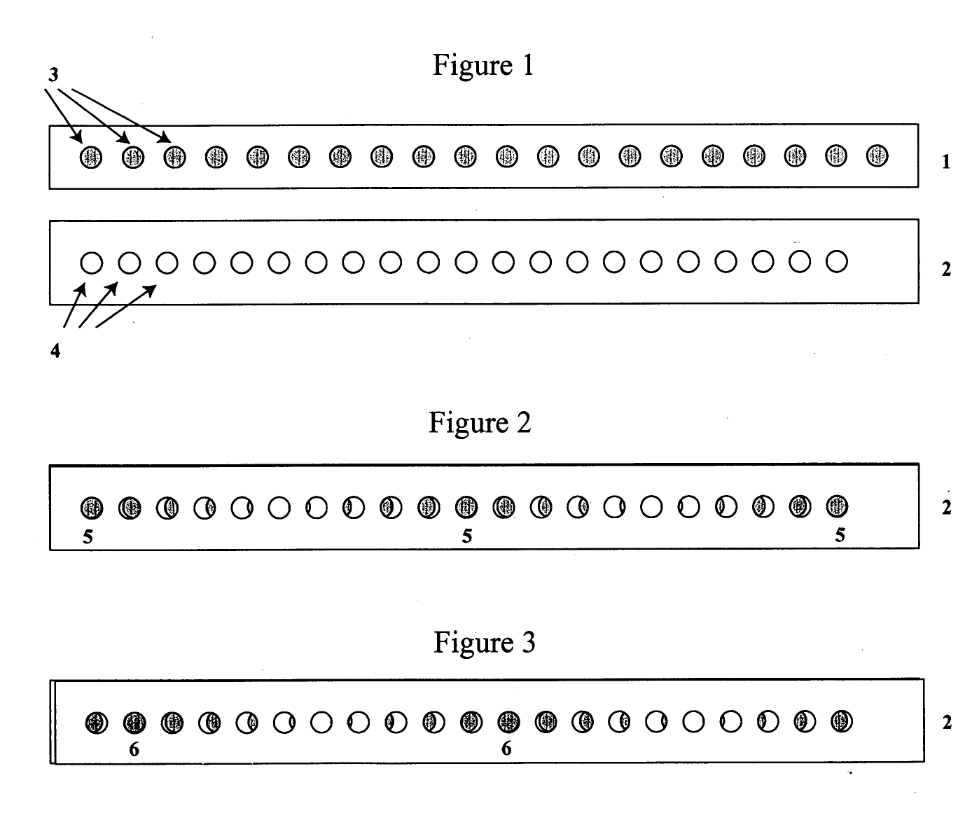

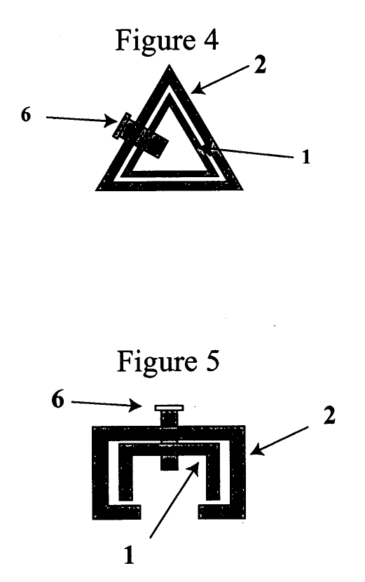

### DESCRIPTION OF THE PREFERRED EMBODIMENT

The preferred embodiment of the invention consists of two triangular tubes, one nested in the other. Each tube has holes arranged in a linear pattern along the axis of the tube. The distances between the holes are different for the two tubes. One tube has holes spaced such that holes are situated in the distance that 9 holes are situated in the other

As one member is moved axially relative to the other, alternative sets of holes will line up to receive a pin which locks the extension distance. A locking mechanism such as a cotter pin mechanism or a spring can be used to insure that the pin remains inserted into the holes until removal is desired.

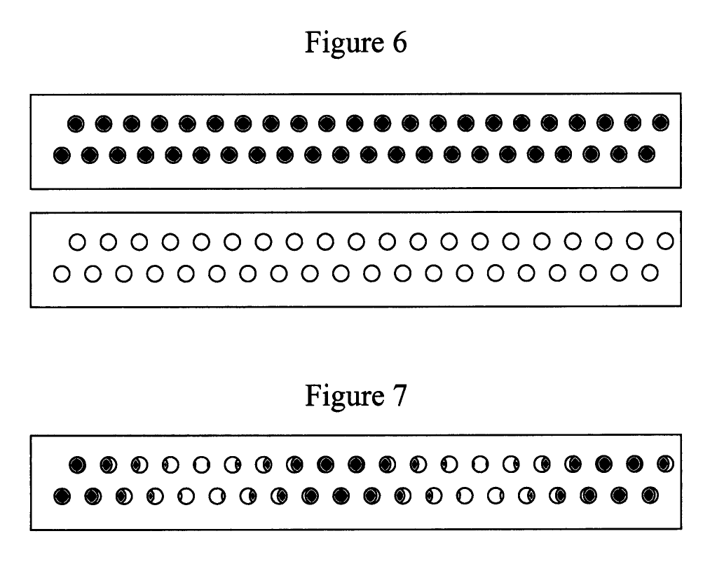

The usual rule in scribing marks for a vernier is that the vernier scale has 10 marks in the distance that the main scale has 9 marks. However, in the present invention, the marks are replaced by holes, which have a significant width. This can interfere with the arrangement of the holes. For example, if the holes have a diameter of 1 centimeter, and it is desired to space the holes every centimeter, the circumferences will touch. However, it is possible to stagger or offset every nth hole in a separate row, permitting proper placement. FIGS. 6 and 7 show an arrangement having two rows of holes in each member. It would be possible for each member to have more than two rows if it that is desired.

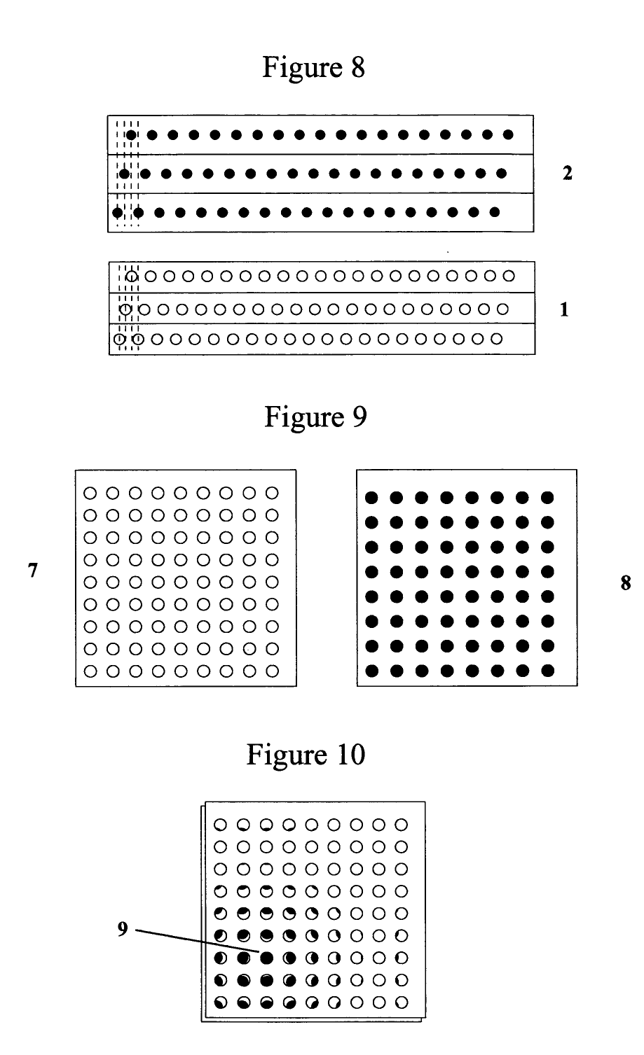

FIG. 8 shows the flattened version of the preferred triangular tubes 1 and 2. Here, each side of each tube has a row of offset holes. Suppose it is desired that on one tube it is desired to have a vernier effect of holes on 1 cm diameter. However, the diameter of the holes is such that if the holes were in one row they would overlap. By placing holes in each side, offset by ⅓ cm. from the first side in the second side and, in the third side, offset by ⅔ of a cm from the first side, we can have the effect of having one row. The dotted lines show the alignment of the holes more clearly. Each row is offset by ⅓ because there are three sides to the triangular rods. Tubes with any number of sides may be used, and in each case the offset would 1/(number of sides).

Although only two tubes are shown in this application, it is possible extend the same principle to multiple nested tubes having locking holes with different pitches FIG. 9 shows two plates 7 and 8, each having a rectangular pattern of holes. The spaces in both dimensions between the holes in plate 8 is 9/10 the distance between the holes in plate 7.

FIG. 10 shows the two plates superimposed and offset slightly in both x and y dimensions. Indicator 9 shows that one set of holes line up. It must be noted that in FIG. 10 only one pair of holes line up. Although a pin through the two holes would secure the two plates together, it would not be sufficient to prevent rotation about the pin. It would be necessary to have a sufficient number of holes so that there will be at least 2 sets of overlapping holes to prevent rotation. This can be achieved by having enough holes to define, in both directions, multiple ‘main scales’ in one plate and ‘vernier scales’ the other plate so that they will have multiple overlapping holes when offset the desired distance.

1. A telescoping structure comprising at least a first member and a second member, said members joined to restrict movement axially; at least one first set of locking holes distributed axially on said first member, said first set of locking holes having a constant distance between them and at least one second set of locking holes distributed axially on said second member; said second set of locking holes having a constant distance between them different from the distance between said first set of locking holes, said first and second set of locking holes being disposed so as to be able to receive a locking mechanism.

2. A telescoping structure as defined in claim 1 where said first and second members comprise two nested triangular tubes.

3. A telescoping structure as defined in claim 2 having locking holes disposed on each face of said at least two nested triangular tubes.

4. A planar assembly consisting of a first plate and a second plate having locking holes in X and Y dimensions, said first plates locking holes having different spacings then said locking holes in second said plate.
